(19) United States
(12) Patent Application Publication
(10) Pub. No.: US 2010/0023768 A1
(43) Pub. Date: Jan. 28, 2010

(54) Method and system for security key agreement

(75) Inventors: Shangping Lin, Shanghai (CN); Steven Su, Shanghai (CN); Yang Chen, Shanghai (CN)

Correspondence Address: PEARL COHEN ZEDEK LATZER, LLP, 1500 BROADWAY, 12TH FLOOR, NEW YORK, NY, 10036, US

(73) Assignee: Intel Corporation

(21) Appl. No.: 11/819,371

(22) Filed: Jun. 27, 2007

(51) Int. Cl. H04L 9/32; G06F 15/16; H04L 9/08

(52) U.S. Cl. 713/171; 709/209; 380/279

(57) ABSTRACT

A method and system for security key agreement is disclosed. The method may include broadcasting a first connectivity association discovery message and receiving a message from a second node on the network; if the second node is not a member of a connectivity association and the message from the second node is a second connectivity association discovery message, one of the first or second nodes may be assigned as a master node. The method may further include the master node sending an authentication request message, receiving an authentication response, sending a session key indication message, receiving a session key acknowledgement message, and broadcasting a connectivity association augment message.

### BACKGROUND OF THE INVENTION

The IEEE 802.1X standard (2004) is an IEEE standard for local area network (LAN) operations that specifies a general method for the provision of port-based network access control. It makes use of the physical access characteristics of LAN infrastructures to provide a system of authenticating and authorizing devices connected to LAN ports with point-to-point connection characteristics.

The IEEE 802.1AE (2006) standard defines media access control (MAC) security for maintaining confidentiality of transmitted data for authorized systems attaching to and interconnecting LANs. It defines an implementation of NIAC security entities (SecYs) within the MAC sublayer. However, key management and establishment of secure connectivity associations which are beyond the scope of 802.1AE, are specified in IEEE 802.1AF which is still in draft form.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a communication system according to an embodiment of the invention.

FIG. 2 is a block diagram of component modules of a MAC layer according to an embodiment of the invention.

FIG. 3 is a flowchart of a method for establishing a secure connectivity association for two nodes according to an embodiment of the invention.

FIG. 4 is a flowchart of a method for MAC security key agreement for adding a node to an existing secure connectivity association according to an embodiment of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

It should be understood that the present invention may be used in a variety of applications. Although the present invention is not limited in this respect, the circuits and techniques disclosed herein may be used in many apparatuses such as personal computers, stations of a radio system, wireless communication system, digital communication system, satellite communication system, and the like.

Stations, nodes and other devices intended to be included within the scope of the present invention include, by way of example only, local area network (LAN) stations and/or nodes, metropolitan area network (MAN) stations and/or nodes, personal computers, peripheral devices, wireless LAN stations, and the like.

Devices, systems and methods incorporating aspects of embodiments of the invention are also suitable for computer communication network applications, for example, intranet and Internet applications. Embodiments of the invention may be implemented in conjunction with hardware and/or software adapted to interact with a computer communication network, for example, a personal area network (PAN), LAN, wide area network (WAN), or a global communication network, for example, the Internet.

Embodiments of the invention may provide a method and apparatus for establishing secure connectivity association (CA) in a LAN. In a LAN, it may be desirable to establish a new CA among two or more participating network stations or nodes. Although the IEEE 802.1AF standard may extend the IEEE 802.1X standard to establish CAs for the IEEE 802.1AE MAC security standard, it may be desirable to establish a new CA or join an existing CA with high efficiency and without requiring heart-beat reception among CA members or an external authentication, authorization, and accounting (AAA) server for auditing an authentication certificate. Furthermore, although the present invention is not limited in this respect, embodiments of the present invention may enable the use of only one session key for symmetric encryption/decryption communication links and may enable each station in the CA to act as an authentication master for any new node attempting to join the CA.

In one embodiment, a method may include broadcasting a first connectivity association discovery message and receiving a message from a second node on the network; if the second node is not a member of a connectivity association and the message from the second node is a second connectivity association discovery message, one of the first or second nodes may be assigned as a master node. The method may further include the master node sending an authentication request message, receiving an authentication response, sending a session key indication message, receiving a session key acknowledgement message, and broadcasting a connectivity association augment message.

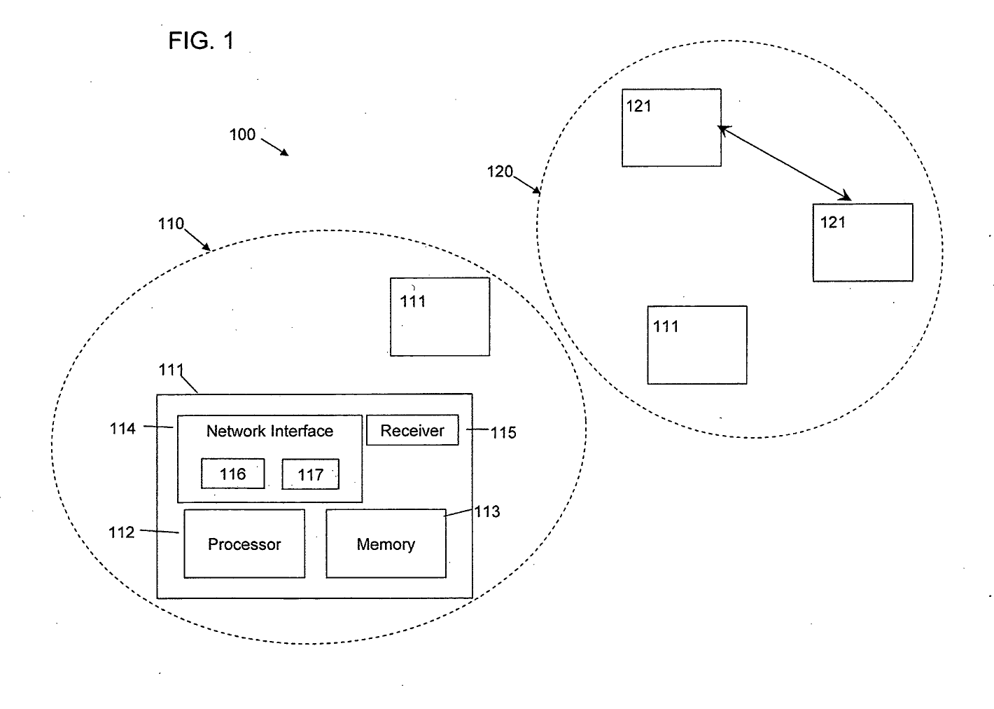

Reference is now made to FIG. 1, a block diagram of a communication system in accordance with an embodiment of the present invention. It will be appreciated by those skilled in the art that the simplified components schematically illustrated in FIG. 1 are intended for demonstration purposes only, and that other or additional components may be required for operation of the wireless devices. Those of skill in the art will further note that the connection between components in a wireless device need not necessarily be exactly as depicted in the schematic diagram.

Although the invention is not limited in this respect, communication system 100 may include or be used in a network environment 110 including two or more stations 111 prior to a network connection between the two or more stations 111 being established and/or at least one network environment 120 including two or more stations 121 and a station 111 capable of joining the network of stations 121. Although not limited in this respect, the network to be established in network environment 110 and the existing network in network environment 120 may be LANs, MANs or other similar networks with communications links between two or more stations. Stations 111 and stations 121 may be similar in that both may be nodes capable of operating on a LAN or MAN and may differ only in that stations 111 may not be connected to a CA while stations 122 may already be members of a CA. Both stations 111 and 121 may include means for establishing a security key agreement in accordance with embodiments of the present invention. Multiple stations 111 and 121 may be able communicate with one another via for example a wired or wireless link.

In some embodiments, station 111 may include for example a processor 112, a memory unit 113, a network interface 114, and a receiver 115. Station 111 may further include other suitable hardware components and/or software components.

Processor 112 may include, for example, a Central Processing Unit (CPU), a Digital Signal Processor (DSP), a microprocessor, a controller, a chip, a microchip, an Integrated Circuit (IC), or any other suitable multi-purpose or specific processor or controller. Processor 112 may, for example, process data received by station 111, and/or process data intended for transmission by station 111.

Memory unit 113 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Memory unit 113 may, for example, store data received by station 111, and/or store data intended for transmission by station 111 and/or store instructions for carrying out the operation of station 111 including for example embodiments of a method described herein.

Network interface 114 may include for example, any interface component able to transmit and or receive communications via a wired or wireless link in accordance with some embodiments of the present invention. Network interface 114 may be implemented using for example a network interface card, a transceiver, a separate transmitter and receiver, or one or more units able to perform separate or integrated functions of transmitting and/or receiving wired or wireless communication signals, blocks, frames, transmission streams, packets, messages and/or data. Network interface 114 may include an implementation of a MAC Security Entity 116 and MAC Security Key Agreement Entity components 117. Alternately, both MAC Security Entity 116 and MAC Security Key Agreement Entity components 117 may be included in whole or in part elsewhere in station 111 such as for example in receiver 115. MAC Security Entity 116 may be implemented according to the IEEE 802.1AE standard, although other implementations may be used, and may operate in conjunction with MAC Security Key Agreement Entity components 117 to facilitate secure communications among similarly configured nodes in network environments such as for example network environments 110 and 120.

Receiver 115 may include, for example, a wireless Radio Frequency (RF) receiver able to receive RF signals in accordance with some embodiments of the present invention. Receiver 115 may be implemented using for example a receiver, transceiver, or a transmitter-receiver, or one or more units able to perform separate or integrated functions of receiving and/or transmitting/receiving wireless communication signals, blocks, frames, transmission streams, packets, messages and/or data

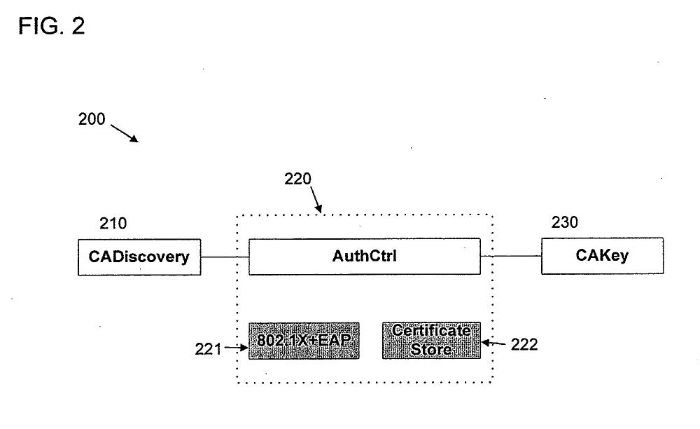

FIG. 2 is a block diagram of a set of MAC Security Key Agreement Entity components 200 that operate according to one embodiment of the invention. MAC Security Key Agreement Entity components or their functionality may be included for example in stations 111 and 121. Although the invention is not limited in this respect, MAC Security Key Agreement Entity components may include CA discovery module 210, authentication control module 220, and CA key generation module 230. These components may be implemented as software, hardware, or a combination of both. In some embodiments, the implementation of these components may be in accordance with the IEEE 802.1AE standard, although other implementations may be used. It will be appreciated by those skilled in the art that the simplified components schematically illustrated in FIG. 2 are intended for demonstration purposes only, and that other components may be included in MAC Security Key Agreement Entity components 200. Furthermore, one or more of the functional elements in FIG. 2 may be combined or separated into one or more units or software modules able to perform separately or together functions of the units shown in the embodiment of FIG. 2. Other or additional components may be included.

Although the invention is not limited in this respect, CA discovery module 210 may be responsible for determining whether a CA is present. In one embodiment, when a station or node operating in accordance with the present invention powers on, CA discovery module 210 may broadcast a CA discovery message to any other nodes present on a LAN.

Authentication control module 220 may manage the authentication certificate auditing and other authentication control functions. Although the functions of authentication control module 220 may be combined or separated into one or more units able to perform separately together functions of the units shown in the embodiment of FIG. 2, the units may include an authentication protocol module 221 and a certificate store 222. In some embodiments, authentication protocol module 221 may operate in accordance with the 802.1X standard and may invoke an extensible authentication protocol (EAP). Other standards and protocols may also be implemented in authentication protocol module 221. Certificate store 222 may store one or more authentication certificates that may be used to establish or join a local CA. Certificate store 222 may also store a list of CA members, although this list may be stored elsewhere in authentication control module 220.

CA key generation module 230 may generate a CA session key when station 111 may be designated as a master node. If another node is designated as a master node, CA key generation module 230 may receive a CA session key from the master node and store it locally.

In one embodiment, two or more stations 111 in network environment 110 that are not members or participants in a CA may boot up at substantially the same time and may attempt to join a CA. Alternately, the two or more stations 111 in network environment 110 may be joined together to form a network such as for example a LAN, thereby triggering their attempts to join a CA. In another embodiment, one or more stations 111 in network environment 120 that are not members in a CA may boot up and may attempt to join a CA that has been established previously between stations 121. Alternately, one or more stations 111 may attempt to join a CA upon being connected to a preexisting network such as for example the LAN connecting stations 121.

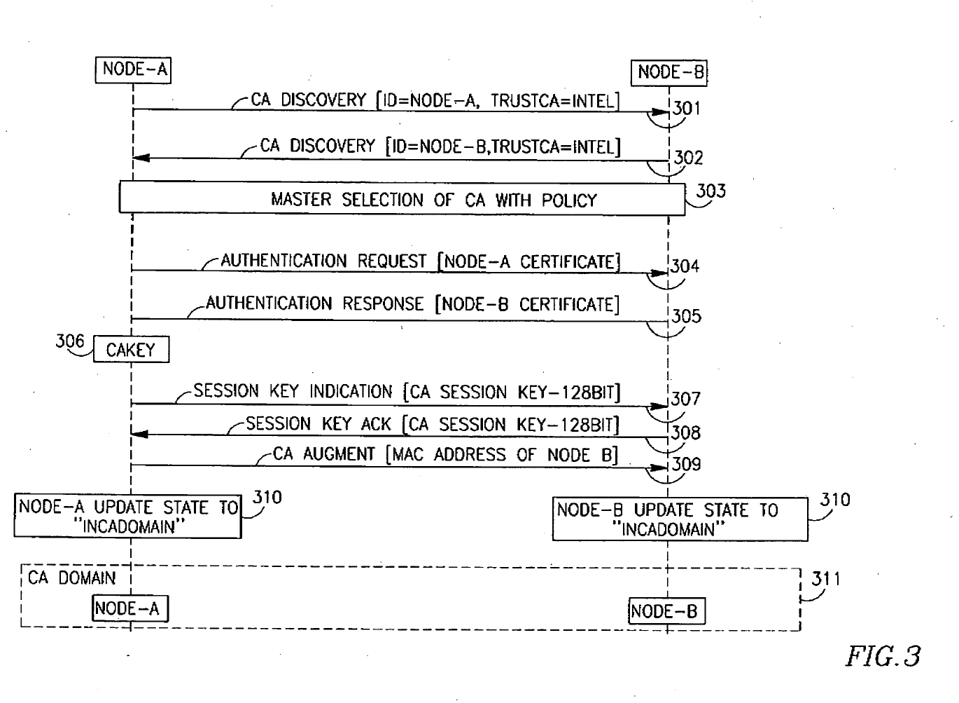

FIG. 3 is a flowchart of a method according to one embodiment of the invention of establishing a CA between two nodes that may be part of the same LAN, may not be members of a CA in accordance with some embodiments of the invention, and may not be booted up. Embodiments of the method may be used by, or may be implemented by, for example, system 100 of FIG. 1, by two or more of stations 111 in network environment 110 of FIG. 1 or by other suitable wired and/or wireless communication devices, stations, nodes, systems and/or networks.

As indicated at step 301, upon booting up, a first node, shown in FIG. 3 as Node-A may send a broadcast message on the LAN to a second node, shown in FIG. 3 as Node-B. The message from Node-A may be for example a CA discovery message for requesting to join a CA on the LAN. The message may include, but may not be limited to the identity of Node-A which may be expressed as Node-A's MAC address. Other information for identifying Node-A may also be used, and other messages may be sent. The CA discovery message may also for example include a trustCA certificate which may be the trusted certificate authority for Node-A. The CA discovery message may further include a state indicator of Node-A with respect to a CA. Because Node-A may not be a member of a CA, the indicator may indicate that Node-A is not a member of CA such as, for example, “outCADomain.”

Although the invention is not limited in this respect, Node-A and Node-B may boot up at substantially the same time. As indicated in step 302, Node-B may also send a CA discovery message which may have the same format as the CA discovery message sent by Node-A. Node-B's CA discovery message may include Node-B's identity, expressed, for example, as Node-B's MAC address, a trusted certificate authority for Node-B and a state indicator with respect to a CA, such as outCADomain. Other formats and messages for Node-B's CA discovery message may also be used.

The message sent by Node-A in step 301 may be received by Node-B, and similarly the message sent by Node-B may be received by Node-A. If other nodes are present, they may also receive the messages sent by both nodes. Because both Node-A and Node-B may not be members of a CA, when they receive the messages sent by Node-B and Node-A respectively, both may be configured to wait a predefined interval for a member of an existing CA to respond, although the invention is not limited in this respect.

If the message sent by either Node-A or Node-B is not received by another node configured to establish a CA in accordance with embodiments of the present invention, the node sending the message may repeat step 301 indefinitely or until it receives a response. In one embodiment, the node sending the message may repeat step 301 until it receives a CA discovery message. Other conditions for terminating the repetition of step 301 may be implemented.

If no member of an existing CA responds within the predefined interval, then one of Node-A and Node-B may be elected in step 303 as a master for subsequent session key generation according to a predetermined policy. In one embodiment, a policy for electing the master may include for example selecting the node with the smallest node identity as the master. Alternately, other policies may be used.

If, for example, Node-A is selected as the master, then Node-A may send an authentication request message to Node-B (step 304). In one embodiment, the authentication request message may be encrypted and include Node-A's authentication certificate and a public key. Other authentication request messages may also be used. In some embodiments, the authentication request message sent by Node-A in step 304 and other nodes in subsequent steps may be sent in accordance with the 802.1X standard and may utilize EAP.

Node-A's authentication request message may be received by Node-B. Although the invention is not limited in this respect, Node-B may audit the authentication certificate in the request message upon receipt of Node-A's authentication request message. In one embodiment, Node-B may decrypt the certificate's data signature with the certificate's public key. If the certificate's signature is the same as the authorized user name in Node-B's certificate, then the certificate may be eligible or compatible. Alternately, other audit methods may be used.

If the received authentication certificate is compatible, then Node-B may send an authentication response message (step 305) to Node-A. In one embodiment, the authentication response message may include Node-B's authentication certificate. Other response messages may also be used.

Node-B's authentication response message may be received by Node-A. Although the invention is not limited in this respect, Node-A may audit the authentication certificate in the response message upon receipt of Node-B's authentication response message. Node-A's audit may use the same method as Node-B, although other auditing methods may be employed. If the received authentication certificate is compatible, then Node-A may generate a session key for secure communications in the local CA domain in step 306. In one embodiment this session key may enable symmetric encryption/decryption in the CA and may be 128 bits in length. Other session key lengths may be used. In one embodiment, Node-A's CA key module 230 may be responsible for session key generation. Other functional units of Node-A may also generate the session key.

In step 307, Node-A may send a session key indication message. Although the invention is not limited in this respect, the session key indication message may include the session key generated in step 306. Furthermore, the session key indication message and all subsequent communications between Node-A and Node-B may be encrypted with for example Node-A or Node-B's public key from Certificate Store 222, thereby securing all subsequent messages in the LAN. Alternately, encryption may be initiated at a later step and/or other encryption techniques and keys may be used.

Node-A's session key indication message may be received by Node-B. Although the invention is not limited in this respect, Node-B may send a session key acknowledgement message upon receipt of Node-A's session key indication message (step 308). This session key acknowledgement message may contain the session key generated by Node-A, although other message contents may be sent.

Node-A may receive the session key acknowledgement message sent by Node-B. Although the invention is not limited in this respect, upon receipt of the session acknowledgement message, Node-A may send a CA augment message to all members of the CA (step 309). In one embodiment, this message may include an indicator of Node-B's identity such as for example, Node-B's MAC address. Other messages and/or other indicators of Node-B's identity may also be used.

In step 310 Node-A and Node-B may update their respective states to reflect their inclusion in a CA. In one embodiment, Node-B may update its state after sending the session key acknowledgement message, while Node-A may update its state after receiving the session key acknowledgement message. Alternately, the respective updates to the state of Node-A and Node-B may be triggered by different events. In one embodiment, the update may for example change the state for both Node-A and Node-B from being registered as outCADomain to “inCADomain”. Other state indicators may also be used.

In step 311, the local CA may now include Node-A and Node-B as members or participants and MAC security service may begin.

Other operations or series of operations may be used.

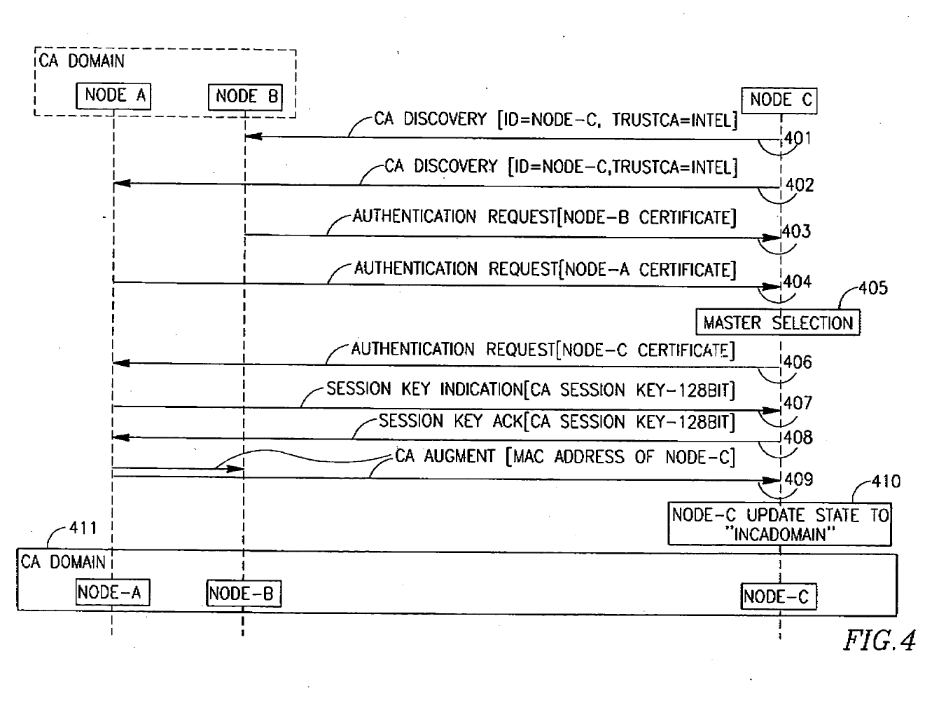

FIG. 4 is a flowchart of a method for a node to join a CA that may exist between two or nodes that may be part of the same LAN, in accordance with one embodiment of the invention. Embodiments of the method may be used by, or may be implemented by, for example, system 100 of FIG. 1, by one or more stations 111 to join a LAN of two or more of stations 121 of FIG. 1 or by other suitable wired and/or wireless communication devices, stations, nodes, systems and/or networks.

In one embodiment, the node that is joining the CA may be booting up and is referred to herein as Node-C. Node-C may send a broadcast message on the LAN that may be received by Node-B and Node-A as indicated at steps 401 and 402 respectively. The broadcast message may be similar to that for step 301 and may be a CA discovery message for requesting inclusion in a CA on the LAN. The CA discovery message from Node-C may include, but may not be limited to the identity of Node-C which may be expressed as Node-C's MAC address. Other information for identifying Node-C may also be used. The CA discovery message may also include a trustCA certificate which may be the trusted certificate authority for Node-C. The CA discovery message may further include a state indicator of Node-C with respect to a CA. Because Node-C may not be a member of a CA, the indicator may indicate that Node-C is not a member of CA such as, for example, outCADomain. Other nomenclatures may be used.

Because both Node-B and Node-A are participants in a CA, Node-B and Node-A may respond by sending an authentication request message to Node-C in steps 403 and 404 respectively, although the invention is not limited in this respect. The content of the authentication message sent by each node may include the authentication certificate of each respective node. Alternately, other messages may be sent. In some embodiments, the authentication request message sent by Node-B and Node-A in steps 403 and 404 and other nodes in subsequent steps may be sent in accordance with the 802.1X standard and may utilize EAP. Other standards may be used.

Node-C may receive the responses from one or both of Node-A and Node-B. Although the invention is not limited in this respect, Node-C may audit the one or more authentication certificates that may be contained in the respective authentication responses that it receives with its own authentication certificate upon receipt of the authentication response. If Node-C receives responses from both nodes, it may select one node to be a master according to a predetermined policy (step 405) and may audit the response from only the node selected to be the master node. In one embodiment, a policy for determining which responding node to select as a master may be the first eligible node that responded. Other policies may also be used.

For this example, Node-A may be the first to respond and may be selected as the master. In step 406, Node-C may send an authentication request message to the node selected as the master such as for example Node-A. This authentication request message may include Node-C's authentication certificate. Other authentication request messages may be used.

Node-A may receive the authentication request message sent by Node-C and may validate Node-C's authentication certificate. If Node-C's authentication certificate is valid, Node-A may respond by sending a session key indication message to Node-C in step 407. Although the invention is not limited in this respect, the session key indication message may include the session key of the pre-existing CA that includes Node-A and Node-B. This session key may be similar to that described above as sent in step 306, although other implementations of session keys may be used.

Upon receipt of the session key indication message sent by Node-A, Node-C may acknowledge its receipt of the session key by sending a session key acknowledge message back to Node-A (step 408).

Node-A may receive the session key acknowledgement message sent by Node-C. Although the invention is not limited in this respect, upon receipt of the session acknowledgement message, Node-A may send a CA augment message to all members of the CA (step 409). In one embodiment, this message may include an indicator of Node-C's identity such as for example, Node-C's MAC address. Other messages and/or other indicators of Node-C's identity may also be used. In some embodiments, the CA augment message may be encrypted with the CA session key.

This CA augment message may be received by any or all members of the local CA such as for example a station 121. Upon receipt of this CA augment message, a member of the CA may put Node-C's identity into its respective list of CA members stored in for example authentication control module 220.

In step 410 Node-C may update its state to reflect its acceptance to a CA. In one embodiment, the update may occur when Node-C sends the session key acknowledgement message and may for example change the state of Node-C from being registered as for example outCADomain to inCADomain.

In step 411, the local CA may now include Node-A, Node-B, and Node-C as members or participants and MAC security service may continue with all three participants.

Other operations or series of operations may be used.

Although the method of FIG. 4 has been described with respect to a single node joining a local CA, the method may be employed by two or more nodes for joining a local CA.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A method comprising:
broadcasting a first connectivity association discovery message from a first node on a network;
receiving a message from a second node on the network;
if the second node is not a member of a connectivity association and the message from the second node is a second connectivity association discovery message, assigning one of the first or second node as a master;
sending from said master node an authentication request message;
receiving at said master node an authentication response;
sending from said master node a session key indication message;
receiving a session key acknowledge message at said master node; and
broadcasting from said master node a connectivity association augment message.

2. The method of claim 1, wherein the session key indication message comprises a session key.

3. The method of claim 1 further comprising waiting a predefined interval after broadcasting said first connectivity association discovery message, and repeating said broadcasting of the connectivity association discovery message until a message from a second node on the network is received within the predefined interval.

4. The method of claim 1, wherein the connectivity association discovery message comprises a node identifier.

5. The method of claim 4, wherein the node identifier is a media access control address.

6. The method of claim 1, wherein said first node and said second node utilize an extensible authentication protocol in accordance with the IEEE 802.1X standard.

7. The method of claim 1, further comprising:
if the second node is a member of a connectivity association with a third node on the network and the message received from the second node is a first authentication request message, assigning the second node as the master;
sending from said first node a second authentication request message;
receiving from said master node a session key indication message;
sending a session key acknowledge message to said master node; and
broadcasting from said master node a connectivity association augment message.

8. A system comprising:
a first node and a second node;
the first node to broadcast on a network a first connectivity association discovery message, to receive a message from the second node, to assign one of the first or second node on the network as a master if the second node is not a member of a connectivity association and the second message from the second node is a second connectivity association discovery message, to send an authentication request message if the first node is assigned as the master, to receive an authentication response, to send a session key indication message, to receive a session key acknowledgement message, and to broadcast a connectivity association augment message.

9. The system of claim 8, wherein the session key indication message comprises a session key.

10. The system of claim 8, wherein the connectivity association discovery message comprises a node identifier.

11. The system of claim 10, wherein the node identifier is a media access control address.

12. The system of claim 8, wherein said first node and said second node utilize an extensible authentication protocol in accordance with the IEEE 802.1X standard.

13. The system of claim 8, wherein the node is further configured to assign the second node as the master if the second node is a member of a connectivity association with a third node and the message received from the second node is a first authentication request message, to send a second authentication request message, to receive a session key indication message, to send a session key acknowledgement message, and to receive a connectivity association augment message from the second node sent upon receipt of the session key acknowledgement message at the second node.
